(19) United States
(12) Patent Application Publication
(10) Pub. No.: US 2023/0291738 A1
(43) Pub. Date: Sep. 14, 2023

(54) METHOD AND SYSTEM OF DYNAMICALLY RETURNING DOMAIN NAME SYSTEM RECORD

(71) Applicant: BunnyWay d.o.o., Medvode (SI)

(72) Inventor: Dejan Grofelnik Pelzel, Medvode (SI)

(21) Appl. No.: 17/692,158

(22) Filed: Mar. 10, 2022

(51) Int. Cl. H04L 9/40; H04L 61/4511; H04L 67/1012; H04L 67/1021

(52) U.S. Cl. CPC H04L 63/102; H04L 63/20; H04L 61/1511; H04L 67/1012; H04L 67/1021

(57) ABSTRACT

Disclosed is a method of dynamically returning a Domain Name System record. The method comprises receiving, by a Domain Name System service (202), a Domain Name System query, initiated by a Domain Name System client (204). Moreover, the method comprises receiving a programmable script (208) from a user associated with the Domain Name System service (202), and executing, by a programmable script execution engine (206), the programmable script (208) to dynamically generate a response (210) based on the Domain Name System query, wherein programmable script execution engine is communicably coupled to the Domain Name System service. Furthermore, the method comprises providing the generated response from the Domain Name System service to the Domain Name System client as the Domain Name System record. Disclosed also is a system (200) of dynamically returning a Domain Name System record.

### TECHNICAL FIELD

The present disclosure relates generally to internet service fields as part of DNS services; and more specifically, to methods of dynamically returning Domain Name System records. The present disclosure also relates to systems of dynamically returning Domain Name System records using the aforementioned methods.

### BACKGROUND

Over the past few decades, the internet has been playing a vital role in everyone's life. Typically, the internet is a global communication system that facilitates a worldwide communication and provides access to data resources. In this regard, the access to data resources is provided through a vast collection of private, public, business, academic and government networks. Moreover, in order to enhance user experience of internet a Domain Name System is typically used to connect to various webpages (or sites) on the internet.

The Domain Name System (DNS) is a globally distributed directory that resolves a domain name into an internet protocol (IP) address. In this regard, the DNS locates (maps) the IP address of the corresponding domain name, from a database associated therewith, to display the website to the user requesting it. However, the DNS may not always map the domain names to their corresponding IP addresses accurately and may only consider pre-defined records that can only be configured upfront. In this regard, the DNS records need to be pre-configured, i.e. the user is required to set a specific host name. It will be appreciated that such pre-configuring limits the possibilities of configuring such a domain name to a specific domain name that is configured.

Therefore, in light of the foregoing discussion, there exists a need to overcome the aforementioned drawbacks associated with the conventional DNS.

### SUMMARY

The present disclosure seeks to provide a method of dynamically returning a Domain Name System record. The present disclosure also seeks to provide a system of dynamically returning a Domain Name System record. The present disclosure seeks to provide a solution to the existing problem of limiting users to only some pre-defined records that may only be configured upfront using conventional domain name systems. An aim of the present disclosure is to provide a solution that overcomes at least partially the problems encountered in prior art, and provides an efficient, secure, reliable, accurate, and a fast system of dynamically returning a Domain Name System record.

In one aspect, an embodiment of the present disclosure provides a method of dynamically returning a Domain Name System record, the method comprising:
receiving, by a Domain Name System service, a Domain Name System query initiated by a Domain Name System client;
receiving a programmable script from a user associated with the Domain Name System service;
executing, by a programmable script execution engine, the programmable script to dynamically generate a response based on the Domain Name System query, wherein the programmable script execution engine is communicably coupled to the Domain Name System service; and
providing the generated response from the Domain Name System service to the Domain Name System client as the Domain Name System record.

Embodiments of the present disclosure substantially eliminate or at least partially address the aforementioned problems in the prior art, and provide an efficient, secure, reliable, accurate, and fast method of dynamically returning a Domain Name System record. Beneficially, by dynamically returning responses, it may be possible to unlock complex routing scenarios, where a same domain name might be needed to return a different result for different scenarios. Advantageously, the method employs a programmable script, run by a programmable script execution engine associated with the DNS service, to dynamically generate a response to the Domain Name System query.

In an embodiment, the method further comprises storing the programmable script in a database associated with the programmable script execution engine.

In an embodiment, the Domain Name System client is at least one of: a server, a machine, a service, and a network device.

In an embodiment, the response is generated based on at least one parameter.

In an embodiment, the at least one parameter is at least one of: a real-time geographic location of the Domain Name System client, a user identifier information, a user preference, and a user authorization information.

In an embodiment, the at least one parameter splits load between servers.

In another aspect, an embodiment of the present disclosure provides a system for dynamically returning a Domain Name System record, the system comprising a Domain Name System service configured to:
receive a Domain Name System query initiated by a Domain Name System client;
execute, by a programmable script execution engine, a programmable script to dynamically generate a response based on the Domain Name System query, wherein the programmable script execution engine is communicably coupled to the Domain Name System service; and
provide the generated response to the Domain Name System client as the Domain Name System record.

In an embodiment, the system further comprises a database, associated with the programmable script execution engine, for storing the programmable script therein.

In an embodiment, the Domain Name System client is at least one of: a server, a machine, a service, and a network device.

In yet another aspect, an embodiment of the present disclosure provides a computer program product for dynamically returning a Domain Name System record, the computer program product comprising a non-transitory machine-readable data storage medium having stored thereon program instructions that, when accessed by a processor, cause the processor to carry out the aforementioned method.

Additional aspects, advantages, features, and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those skilled in the art will understand that the drawings are not to scale. Wherever possible, like elements have been indicated by identical numbers.

Embodiments of the present disclosure will now be described, by way of example only, with reference to the following diagrams wherein:

FIG. 1 is a flowchart of steps of a method of dynamically returning a Domain Name System record, in accordance with an embodiment of the present disclosure; and FIG. 2 is a block diagram of a system of dynamically returning a Domain Name System record, in accordance with another embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In one aspect, an embodiment of the present disclosure provides a method of dynamically returning a Domain Name System record, the method comprising:
receiving, by a Domain Name System service, a Domain Name System query initiated by a Domain Name System client;
receiving a programmable script from a user associated with the Domain Name System service;
executing, by a programmable script execution engine, the programmable script to dynamically generate a response based on the Domain Name System query, wherein the programmable script execution engine is communicably coupled to the Domain Name System service; and
providing the generated response from the Domain Name System service to the Domain Name System client as the Domain Name System record.

In another aspect, an embodiment of the present disclosure provides a system of dynamically returning a Domain Name System record, the system comprising a Domain Name System service configured to:
receive a Domain Name System query initiated by a Domain Name System client;
execute, by a programmable script execution engine, a programmable script is to dynamically generate a response based on the Domain Name System query, wherein the programmable script execution engine is communicably coupled to the Domain Name System service; and
provide the generated response to the Domain Name System client as the Domain Name System record.

In yet another aspect, an embodiment of the present disclosure provides a computer program product for dynamically returning a Domain Name System record, the computer program product comprising a non-transitory machine-readable data storage medium having stored thereon program instructions that, when accessed by a processor, cause the processor to carry out the aforementioned method.

The present disclosure relates to the aforementioned method and the aforementioned system of dynamically returning the Domain Name System record for the user query (namely, the Domain Name System query) initiated by the user of a device (namely, the Domain Name System client), by employing the programmable script executed on each of the user query to generate a response (namely, the Domain Name System record). The method and the system of the present disclosure provide dynamic results that are accurate and generated on the fly to enhance the overall user experience.

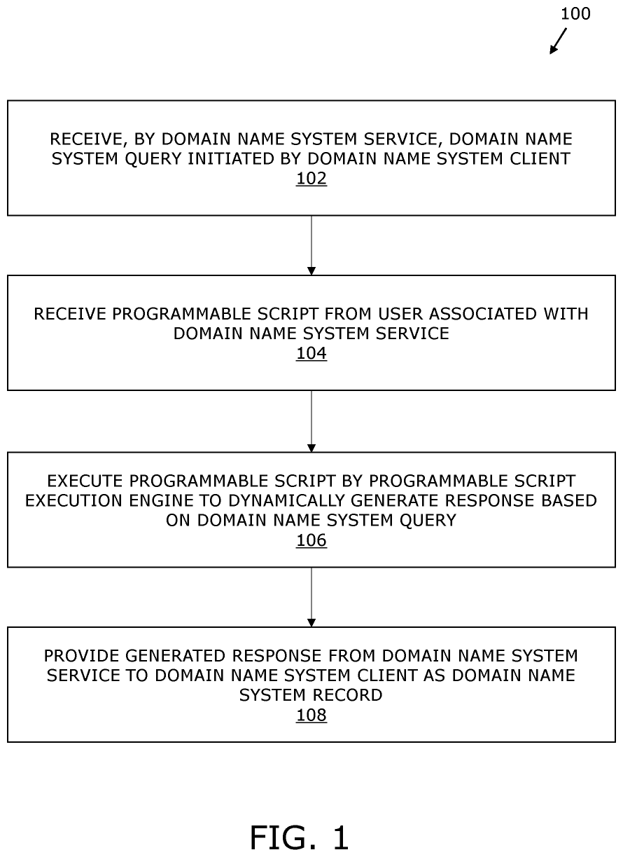

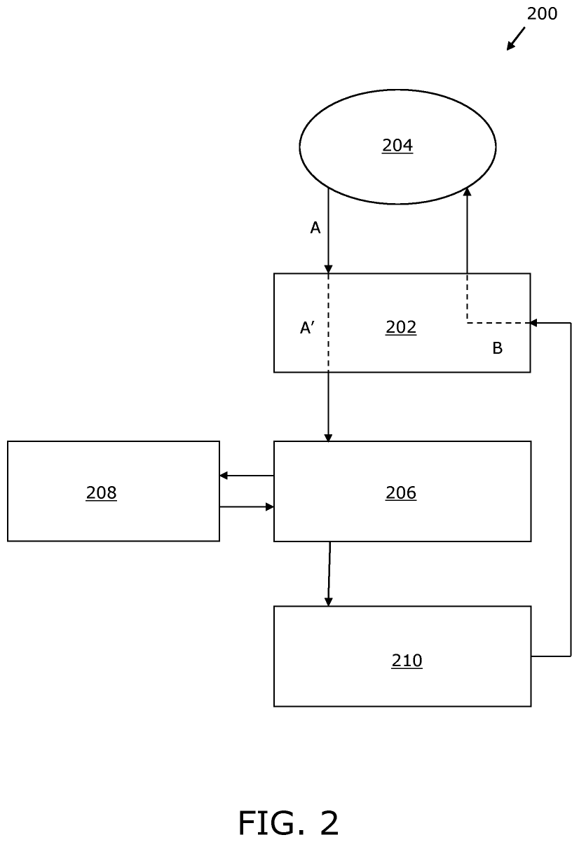

Referring to FIG. 1, there is illustrated a flowchart 100 of steps of a method of dynamically returning a Domain Name System record, in accordance with an embodiment of the present disclosure. At step 102, a Domain Name System query, initiated by a Domain Name System client, is received by a Domain Name System service. At step 104, a programmable script is received from a user associated with the Domain Name System service. At step 106, the programmable script is executed by a programmable script execution engine to dynamically generate a response based on the Domain Name System query, wherein the programmable script execution engine is communicably coupled to the Domain Name System service. At step 108, the generated response is provided from the Domain Name System service to the Domain Name System client as the Domain Name System record.

The steps 102, 104, 106, and 108 are only illustrative and other alternatives can also be provided where one or more steps are added, one or more steps are removed, or one or more steps are provided in a different sequence without departing from the scope of the claims herein.

Referring to FIG. 2, there is illustrated a block diagram of a system 200 of dynamically returning a Domain Name System record, in accordance with another embodiment of the present disclosure. The system 200 for dynamically returning a Domain Name System record comprises a Domain Name System service 202. The Domain Name System service 202 is configured to receive a Domain Name System query (depicted by line A) initiated by a Domain Name System client 204. Moreover, the Domain Name System service 202 is configured to execute, by a programmable script execution engine 206, a programmable script 208 to dynamically generate a response 210 based on the Domain Name System query, wherein the programmable script execution engine 206 is communicably coupled to the Domain Name System service 202. Optionally, besides the programmable script execution engine 206 the Domain Name System service 202 may store or process the Domain Name System query received thereby, as depicted by line A′. Furthermore, the Domain Name System service 202 is configured to provide the generated response 210 to the Domain Name System client 204 as the Domain Name System record via the Domain Name System service 202 (depicted by line B).

The present disclosure provides the aforementioned method and the aforementioned system of dynamically returning a Domain Name System record. In this regard, the method employs a programmable script from a user to dynamically returning a Domain Name System (DNS) record. Beneficially, the programmable script is executed, by a programmable script execution engine, with each DNS query that is initiated at the DNS service. The result of the programmable script is then used to generate a response that is provided as the Domain Name System record to the Domain Name System client. Moreover, the response is generated on the fly, thereby, enhancing the overall user experience. Furthermore, the responses are specific and generated based on one or more parameters that help for example split load between servers, route users to different regions, or interconnect with other systems to provide specific responses based on a set of parameters.

Throughout the disclosure, the term “Domain name system” as used herein refers to a hierarchical and decentralized naming system used to identify computers, services, and other resources reachable through the Internet or other Internet Protocol (IP) networks. The DNS most commonly maps human-readable domain names to corresponding machine-readable IP addresses to locate devices and services over a network protocols (such as Internet, LAN, WAN, and so forth). The term “Internet Protocol address” as used herein refers to a unique address that identifies a device or a service on the internet or a local network. Typically, the Internet Protocol (IP) address sets the rules for governing the data to be sent via the internet or local network. The IP address may be, for example, a numerical label such as 192.60.282.13 used to connect the device to the network protocol. Notably, the IP address provides network interface identification and location addressing. Moreover, various types of IP addresses may be used to identify a device or service. For example, IP version 4 (IPv4) use 32 bits for the IP address (for example, 192.60.282.13) and IP version 6 (IPv6), use 128 bits for the IP address (for example, 2001:db8::8a2e:370:7334). For example, the domain name associated with google is “google.com” and the IP address corresponding thereto is “198.62.121.05”.

Typically, the Domain name system (DNS) translates (or maps) the domain name to a corresponding IP address. Typically, initially, the DNS checks for the requested DNS query in a local cache of the browser. If the requested domain name is not available in the local cache, then the DNS look in the associated network protocol(s). If the requested domain name is found in the network protocols(s), the DNS will return the result for the requested DNS query to the DNS client 204. However, if the domain name is not found in the network protocols(s), a DNS will forward the DNS query further up in hierarchical architecture thereof to resolve the DNS query. In this regard, notably, the DNS hierarchical architecture comprises a Root Name server, Top Level Domain (TLD) Name server, and Authoritative Name server. Moreover, the Root Name server maintains and provides a list of authoritative name servers for each of the top-level domains (.com, .org, and the like). The Top Level Domain (TLD) Name server maintains and provides a list of authoritative name servers for all domains and find the authoritative name server for the requested domain name.

The term “Domain name system record” as used herein refers to a record that is used to map a uniform resource locator (URL) associated with a domain name to the IP address. The DNS record is stored in a database associated with the DNS and allows the DNS client 204 to connect to the device, service or other resources corresponding to the domain name. Notably, when the URL is entered and searched in the browser, the URL is forwarded to the DNS servers and then directed to a specific Web server to load the website corresponding to the entered URL. The DNS record may include, but are not limited to, A (address) record, CNAME (canonical name) record, MX (mail exchange) record, NS (name server) record, PTR (pointer) record, SOA (start of authority) record TXT (text) record, and so forth.

The term “Domain Name System service” as used herein refers to a service that is configured to run a DNS server. Typically, the DNS service 202 can also be self-hosted by running on generic Internet hosting services. Optionally, the DNS services 202 may be existing independently or provided by a third-party. Furthermore, the DNS service 202 offers support for DNS over HTTPS (DoH) and DNS over TLS (DoT) security features. Beneficially, the DNS service 202 is optimal when the internet service provider has multiple servers in various geographic locations that provide resilience and minimize latency for the Domain Name System client 204. It will be appreciated that operating DNS nodes closer to the Domain Name System client 204 may reduce the travel time for the DNS query to a shorter distance, resulting in faster Web address resolution speed. Optionally, the DNS service 202 may be used in cloud computing or IT services.

The term “Domain Name System query” as used herein refers to a request for information that is send from the DNS client 204 to the DNS service 202. Typically, the DNS query is a generally used to obtain the IP address corresponding to the domain name. Moreover, the DNS Query received from the Domain Name System client 204 contains a word, a phrase or a sentence that the DNS client 204 is trying to resolve.

The term “Domain Name System client” as used herein refers to a user device, associated with a user, configured to initiate the DNS query to the DNS service 202. The term “user” as used herein refers to any entity such as a person (i.e., human being), a virtual program (such as, an autonomous program or a bot) that is associated with or operates the DNS client 204 or operates the user-interface rendered on the display of the DNS client 204. Furthermore, the DNS client 204 is intended to be broadly interpreted to include any electronic device that may be used for accessing the DNS.

Optionally, the Domain Name System client 204 is at least one of: a server, a machine, a service, and a network device. The term “server” as used herein refers to a computer hardware or a software (computer program) that provides functionality for other programs or devices. In this regard, the servers may provide various functionalities such as sharing data or resources among multiple clients, or performing computation for the DNS client 204. Beneficially, a single server may serve multiple DNS clients 204, and a single DNS client 204 may use multiple servers. Typically, a client-server system is implemented by (and often identified with) the request-response model. The term “machine” as used herein refers to a hardware device such as a computer, a laptop, a mobile, and so forth, configured to send name resolution queries to the DNS server. The term “service” as used herein refers to for example communications, storage, and processing benefits to users. Optionally, the service may be provided by one or more service providers that may be a third party such as an application service providers (ASPs), a storage service providers (SSPs), an internet service providers (ISPs), and so forth. The term “network device” as used herein refers to a physical device that allows communication and interaction between different hardwares on a computer network. Optionally, the network device may be a Hub, a Switch, a Router, a Bridge, a Gateway, a Modem, and so forth. Optionally, the network devices enable building a secure network. In this regard, when in use, the DNS client 204 is configured to initiate the DNS query to the DNS service 202. Optionally, the DNS client 204 may include, but is not limited to, cellular phones, personal digital assistants (PDAs), handheld devices, laptop computers, personal computers, and so forth.

The term “programmable script” as used herein refers to a code configured to enable the DNS service 202 to dynamically generate the DNS record in response to the DNS query. It will be appreciated that the user providing the programmable script 208 may be same as the user associated with the DNS client 204 or different user. Optionally, the user may be an operator of the DNS service 202 and may include a person or a bot. Typically, the programmable script 208 is executed, by the programmable script execution engine 206, with each DNS query that is received by the DNS service 202 from the DNS client 204. In this regard, the programmable script 208 is received from the user and is then configured on the DNS service 202. When the DNS client 204 initiates the DNS query, at least one parameter from the DNS query is then passed to the programmable script 208 to generate a response 210. The result (namely, response 210) of the execution of the programmable script 208 for a given DNS query is provided as the DNS record to the user corresponding to the given DNS query. Optionally, the programmable script 208 may be a JavaScript, Bash, PowerShell, Python, and so forth. Optionally, the programmable script 208 may be a programming language for a runtime system that automates the execution of tasks that would otherwise be performed individually by a human operator.

The term “programmable script execution engine” as used herein refers to an arrangement of physical or virtual computational entities such as a processing arrangement that includes programmable components configured to store, process and/or share information. It will be appreciated that the programmable script execution engine 206 may be a single hardware, software or a plurality of hardware processing arrangements operating in a parallel or distributed architecture.

The method further comprises storing the programmable script 208 in a database associated with the programmable script execution engine 206. The term “database” as used herein refers to an organized collection of structured information, or a data, typically stored electronically in the system. In this regard, the database may store a plurality of programmable scripts to be used later when the DNS client 204 generates the same DNS query again and the responses 210 thereto. More optionally, the database may be hardware, software, firmware, and/or any combination thereof. For example, the organized body of digital information may be in a form of a table, a map, a grid, a packet, a datagram, a file, a document, a list or in any other form. Optionally, the database may be communicably coupled to the programmable script execution engine 206 via a communication network. In an example, the communication network includes but is not limited to, a cellular network, short-range radio (for example, such as Bluetooth®), Internet, a wireless local area network, and an Infrared Local Area Network, or any combination there. Herein the data refers to information or a set of values of qualitative or quantitative variables that has been translated into a form that is efficient for processing. Optionally, small databases may be stored on a file system, while large databases may be hosted on computer clusters or a cloud storage.

Optionally, the response 210 is generated based on at least one parameter. The term “at least one parameter” as used herein refers to one or more characteristics or any rules that may be used for generating the response 210 corresponding to the DNS query. In this regard, the DNS query is defined or classified based on the at least one parameter in order to get it resolved. Optionally, the at least one parameter may be independent of the DNS client 204. Optionally, the at least one parameter may be stored as a default setting in the database associated with the DNS service 202. Such parameters include, but are not limited, to the hostname requested by the DNS client 204, IP address of the DNS client 204, geographical location of the DNS client 204 and more.

Optionally, the at least one parameter is at least one of: a real-time geographic location of the Domain Name System client 204, a user identifier information, a user preference, and a user authorization information. The term “real-time geographic location” as used herein refers to a position or location (such as latitude and longitude coordinates, or more practically, a physical address) of the user or a device at a given instance of time. In this regard, the real-time geographic location may use location technologies such as a global positioning system (GPS), the IP address, cell phone towers, Wi-Fi®, access points or a combination thereof to identify and track the whereabouts of connected electronic devices or the user generating the Domain Name System query. Optionally, the real-time geographic location enables the DNS client 204 connected to the Internet, to obtain all types of information in real time and locate the user with pinpoint accuracy at a given point in time. The term “user identifier information” as used herein refers to a unique set of information for identifying the user. Optionally, the user identifier information may be used to determine which DNS server the user may access to generate the quick response 210 to the DNS query. The term “user preference” as used herein refers to specific settings that may be customized for a particular user. In this regard, the user preferences editor is available in the web client. The editor allows each user to update values for the preferences. For example, the user preference may include settings of the time zone. The term “user authorization information” as used herein refers to a function of specifying access rights or privileges to resources, that is related to general information security and computer security, and to access control in particular. In other words, the user authorization information refers to defining an access policy. For example, the DNS service 202 may be authorized to access certain web pages and the access policy may be formalized as access control rules in the DNS system. Optionally, when in operation, the DNS service 202 may use the access control rules to decide whether access requests from authenticated users shall be approved (namely, granted) or disapproved (namely, rejected).

Optionally, the at least one parameter splits load between servers. In this regard, the at least one parameter enables distributing web traffic across different geographic location of the DNS client 204. Beneficially, splitting the load between servers enhances availability, efficiency, and security of the network. Optionally, the at least one parameter splits load between servers for network traffic management. Furthermore, the network traffic management allows network administrators to significantly increase the overall network application performance and improve efficiency by routing and filtering packets based on content in their payloads or headers.

The present disclosure also relates to the system as described above. Various embodiments and variants disclosed above apply mutatis mutandis to the system.

Optionally, the system further comprises a database, associated with the programmable script execution engine 206, for storing the programmable script 208 therein.

Optionally, the Domain Name System client 204 is at least one of: a server, a machine, a service, and a network device.

The present disclosure also relates to the computer program product as described above. Various embodiments and variants disclosed above apply mutatis mutandis to the computer program product.

The computer program product for dynamically returning a Domain Name System record, the computer program product comprising a non-transitory machine-readable data storage medium having stored thereon program instructions that, when accessed by a processor, cause the processor to carry out the aforementioned method.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A method of dynamically returning a Domain Name System record, the method comprising:
receiving, by a Domain Name System service, a Domain Name System query initiated by a Domain Name System client;
receiving a programmable script from a user associated with the Domain Name System service;
executing, by a programmable script execution engine, the programmable script to dynamically generate a response based on the Domain Name System query, wherein the programmable script execution engine is communicably coupled to the Domain Name System service; and
providing the generated response from the Domain Name System service to the Domain Name System client as the Domain Name System record.

2. A method according to claim 1, further comprising storing the programmable script in a database associated with the programmable script execution engine.

3. A method according to claim 1, wherein the Domain Name System client is at least one of: a server, a machine, a service, and a network device.

4. A method according to claim 1 any of the preceding claims, wherein the response is generated based on at least one parameter.

5. A method according to claim 4, wherein the at least one parameter is at least one of: a real-time geographic location of the Domain Name System client, a user identifier information, a user preference, and a user authorization information.

6. A method according to claim 5, wherein the at least one parameter splits load between servers.

7. A system for dynamically returning a Domain Name System record, the system comprising a Domain Name System service configured to:
receive a Domain Name System query initiated by a Domain Name System client;
execute, by a programmable script execution engine, a programmable script to dynamically generate a response based on the Domain Name System query, wherein the programmable script execution engine is communicably coupled to the Domain Name System service; and
provide the generated response to the Domain Name System client as the Domain Name System record.

8. A system according to claim 7, further comprising a database, associated with the programmable script execution engine, for storing the programmable script therein.

9. A system according to claim 7, wherein the Domain Name System client is at least one of: a server, a machine, a service, and a network device.

10. A computer program product for dynamically returning a Domain Name System record, the computer program product comprising a non-transitory machine-readable data storage medium having stored thereon program instructions that, when accessed by a processor, cause the processor to carry out the method of claim 1.
